(19) United States
(12) Patent Application Publication
(10) Pub. No.: US 2004/0107585 A1
(43) Pub. Date: Jun. 10, 2004

(54) Shaver extension arm assembly and method

(76) Inventor: Christopher M. Helmrich, Spring, TX (US)

Correspondence Address: KENNETH L. NASH, P.O. BOX 680106, HOUSTON, TX, 77268-0106, US

(21) Appl. No.: 10/314,788

(22) Filed: Dec. 9, 2002

(51) Int. Cl. B26B 21/52

(52) U.S. Cl. 30/537; 30/526

(57) ABSTRACT

The present invention provides a system and method for shaving remote areas of the body which are otherwise difficult to reach. The system preferably provides an extension arm having a connector on an end thereof which is adapted for connecting to the handle of a standard razor blade. In one preferred embodiment, the handle of the standard razor blade is inserted into a receptacle where the handle is affixed by a compressing element such as a clamp or elastomeric element. The system also comprises an adaptor to attach the extension arm to an electric razor. The adaptor preferably includes a handle portion that is preferably elongated, shaped simililarly to the handle of a standard razor blade, and/or also is insertable into the receptacle.

### TECHNICAL FIELD

The present invention relates generally to an assembly for a shaver extension arm and, more particularly, to a connector/adaptor assembly that, among other advantages, permit shaving with either a razor blade or an electric razor.

### BACKGROUND ART

Extension arms for razor blades to reach and shave remote parts of the body are well known in the art. However, such extension arms are limited with respect to the types of blade razors they are capable of supporting and also limited as to the type of shaving that may conveniently be accomplished. As one example, in the cases where longer hair is to be shaved, the types of razors available for use with an extension arm as known in the art are substantially unsuitable to first cutting the hair to a shorter length so that a blade razor can be utilized for fine shaving.

The following patents describe previous attempts made in the prior art to address the above problems:

U.S. Pat. No. 5,911,480, issued Jun. 15, 1999, to D. K. Morgan discloses a razor having an extendable, telescoping handle wherein the handle has at least one telescoping segment which is slidingly movable and frictionally securable to a number of extendable positions. Preferably, the handle is flexible and resilient to allow the razor blade to conform closely to the contours of the body portion being shaved. The telescoping handle can be removed and secured to a variety of razors, such as disposable razors.

U.S. Pat. No. 6,266,888 B1, issued J, to D. K. Morgan discloses a reaching razor having a head portion, a handle and an elongated, flexible neck having a head attachment end opposite a handle attachment end. The head portion is affixed to the head attachment end and the handle is attached to the handle attachment end such as to as allow the user the ability to articulate the head attachment end in relation to the handle attachment end fully about the lateral centerline of the handle.

U.S. Pat. No. 4,905,372, issued Mar. 6, 1990, to W. W. Willis, discloses a razor handle extension which is adapted to be detachably connected to the handle of a disposable razor to effectively increase the length of the handle and thereby permit a female user to more easily and safely shave her legs from an erect position. The razor handle extension has a gripping area at one end thereof. The opposite end includes a hollow receptacle for receiving and retaining the razor handle. A locking ring fits over the receptacle end of the razor handle extension for holding the razor handle there within.

U.S. Pat. No. 5,600,887, issued February 1997, to B. Olson, discloses a flexible razor that includes a blade cartridge having a pair of opposing ends, an elongated handle, a flexible neck coupled to the handle, and a pair of mounting arms extending from the neck and securing the ends of the blade cartridge. In the preferred embodiment, the flexible neck can be protracted into and retracted from the handle by turning a rotatable cuff coupled to the handle. In yet another embodiment, the razor is provided with a flume attached to the flexible neck that is capable of converting a normal circular-shaped water stream into a substantially rectangular-shaped stream and directing the substantially rectangular-shaped stream through the blade cartridge.

U.S. Pat. No. 5,167,069, issued Dec. 1, 1992, to K. H. Quinn, discloses a razor shaving apparatus having a telescopically extendable and retractable body with a manual handle at one end and a pivoting razor shaving assembly at its opposite end, and having a soap or lotion applicator detachably secured to the razor shaving assembly.

U.S. Pat. No. 6,052,905, issued Apr. 25, 2000, to Branchinelli et al., discloses a razor for shaving and sculpting an area of hair on a user. The razor includes a first standard size razor head, a second narrow size razor head including a telescopic member extending therefrom and a handle including a top side integrally connected to the first standard size razor head. A first recess extends through the top side and into the handle forming a compartment. A second recess extends along a length of the handle and provides access to the compartment. The telescopic member is received by the compartment and is slideable therein. A slideable member is connected to the telescopic member and extends through the second recess for sliding the telescopic member within the compartment whereby movement of the slideable member moves the second narrow size razor head between a first extended position in which the telescopic member extends substantially totally from the compartment and a second retracted position in which the telescopic member is substantially completely received within the compartment. Alternatively, the second narrow size razor head may also be integrally connected to the handle. Finally, the narrow size razor head may also be connected to an elongated handle by itself.

U.S. Pat. No. 4,129,942, issued Dec. 19, 1978, to N. H. Denizman, discloses a shaving implement defining a shaving head and a handle having an end portion carrying the shaving head for manipulation of the implement in a normal shaving razor manner. The handle further defines at least one chamber for holding dispensable shaving-associated, or grooming, material, such as shaving cream, aftershave lotion, pre-shave lotion deodorant, etc. Structure is provided for retaining the shaving-associated material removably within the handle of the implement. The shaving-associated material may be retained directly in a chamber defined by the handle or may be retained in a container removably received within the handle. A removable handle portion defining a second chamber for holding such shaving-associated material may further serve as a closure for a chamber in a first portion of the handle arranged to receive a different shaving-associated material.

U.S. Pat. No. 3,233,324, issued Feb. 8, 1966, to J. van der Heide, discloses an electric hair clipper attachment for use with a rotary dry shaver having a drive shaft. The hair clipper comprises a housing having a slot at one end, means in the housing connected to the drive shaft for converting the rotary motion to reciprocating motion, and a set of relatively reciprocating blades projecting through the slot with clearance and operatively connected to the means. The housing and blade set are provided with corresponding studs and recesses. A spring in the housing normally urges the corresponding studs and recesses into engagement with each other with a depth of engagement substantially perpendicular to the plane of the blade set. The blade set is adapted to be displaced transversely to the longitudinal axis of the housing against the pressure of the spring to disengage the studs and corresponding recesses and permit the blade set to be removed forwardly through the slot.

The above cited prior art does not provide a suitable means for cutting longer hair on remote areas. Consequently, there remains a need to provide an improved wheel chock construction. Those of skill in the art will appreciate the present invention which addresses the above problems and other problems.

### SUMMARY OF THE INVENTION

Accordingly, it is an objective of the present invention to provide an improved shaving system and method.

These and other objectives, features, and advantages of the present invention will become apparent from the drawings, the descriptions given herein, and the appended claims. However, it will be understood that the above-listed objective and/or other objectives, features, and advantages of the invention are provided only as an aid in understanding aspects of the invention, and are not intended to limit the invention in any way, and therefore do not form a comprehensive or restrictive list of objectives, and/or features, and/or advantages of the invention.

The present invention comprises a shaving system for shaving one or more remote areas of the body. In one preferred embodiment, the user may selectively utilize either a manual razor with a blade or an electric razor. The system may comprise one or more elements such as, for example only, an extension arm having a length suitable for reaching the one or more remote areas of the body and an extension arm connector carried by the extension arm. The extension arm connector may be alternatively removably securable to either the manual razor handle or the electric razor housing.

The system may further comprise an electric razor adaptor for connecting between the extension arm connector and the electric razor housing. The electric razor adaptor may comprise a first portion shaped at least substantially similar to the manual razor handle such that the first portion is selectively and removably securable to the extension arm connector in the same manner as is the manual razor handle. A second portion of the electric razor adaptor is securable to the electric razor housing. The first portion and the second portion may be secured together such that the electric razor is thereby selectively attachable to the extension arm by means of the electric razor adaptor.

In one embodiment, the extension arm connector defines therein a receptacle for receiving the manual razor handle. The system may further comprise a compressing member for the receptacle for securing the manual razor handle within the receptacle of the extension arm connector. The compressing member may comprise an elastomeric portion and/or a clamp.

In another embodiment, the shaving system may comprise an extension arm having a length suitable for reaching the one or more remote areas of the body and an extension arm connector carried by the extension arm wherein the extension arm connector defines therein a receptacle suitably sized for receiving the manual razor handle whereby the connector is releaseably secureable with the manual razor handle. In some embodiments, the receptacle is defined by internal walls for friction fitting with the manual razor handle. If desired, the internal walls may be tapered for better friction fitting but the internal walls could also be straight. The the internal walls may comprise a compressible material but may also be metallic, plastic, or elastomeric. A compressing member may also be provided for the receptacle, if desired, for releaseably securing the manual razor handle within the receptacle of the extension arm connector. The compressing member may comprise at least one elastomeric portion and/or may comprise a clamp.

In operation, a method is provided which may comprise one or more steps such as, for example only, securing the electric razor to an extension member, removing the electric razor from the extension member, and securing a handle of the manual razor to an extension member.

### BRIEF DESCRIPTION OF DRAWINGS

For a further understanding of the nature and objects of the present invention, reference should be had to the following detailed description, taken in conjunction with the accompanying drawings, in which like elements may be given the same or analogous reference numbers and wherein:

FIG. 1 is an elevational view, partially in section, of a shaving system for use with a standard razor blade in accord with one possible embodiment of the present invention;

FIG. 1B is an elevational view, partially in section, of a shaving system for use with an electric razor in accord with one possible embodiment of the present invention;

FIG. 2A is an elevational view, partially in section, of an extension arm connector for receiving a handle of a razor blade shaver in accord with one possible embodiment of the present invention;

FIG. 2B is an elevational view, partially in section, of an extension arm connector showing therein a handle of a razor blade shaver in accord with one possible embodiment of the present invention;

FIG. 3 is an elevational view, partially in section, of an extension arm connector for receiving a handle of a razor blade shaver in accord with one possible embodiment of the present invention;

FIG. 4 is an elevational view, partially in section, of an extension arm connector for receiving a handle of a razor blade shaver in accord with one possible embodiment of the present invention;

FIG. 5 is an elevational view, partially in section, of an extension arm connector for receiving a handle of a razor blade shaver in accord with one possible embodiment of the present invention;

FIG. 6A is an elevational view of an adaptor to an electric razor blade attachable to an extension arm connector in accord with one possible embodiment of the present invention; and

FIG. 6B is an elevational view, partially in section, of the adaptor of FIG. 6A secured to an extension arm connector in accord with one possible embodiment of the present invention.

While the present invention will be described in connection with presently preferred embodiments, it will be understood that it is not intended to limit the invention to those embodiments. On the contrary, it is intended to cover all alternatives, modifications, and equivalents included within the spirit of the invention.

### GENERAL DESCRIPTION AND PREFERRED MODES FOR CARRYING OUT THE INVENTION

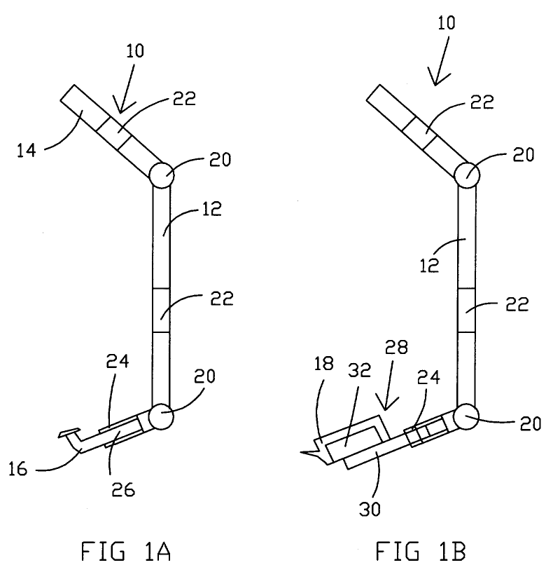

Now referring to the drawings, and more particularly to FIG. 1A and FIG. 1B, there is shown an elevational view of shaver system 10 in accord with one possible embodiment of the present invention. Shaver system 10 may be utilized to shave remote areas of the body such as, for instance, the back and/or the lower portion of the legs that are otherwise either difficult or practically impossible to reach by a user.

Shaver system 10 comprises extension arm 12. Extension arm 12 has a handle 14 that may be held by the user when shaving the remote areas while using a manual razor blade such as manual razor blade 16 or an electric razor blade 18. Manual razor blade 16 may be of any standard construction and electric razor blade 18 may comprise a housing of any suitable shape, as discussed hereinafter. Extension arm 12 may have many variations. Extension arm 12 may simply be a one piece fixed construction. Alternatively extension arm 12 may utilize joints, such as joints 20, telescoping sections such as telescoping sections 22, flexible portions, and the like. Therefore it will be understood that the present invention may be utilized with any suitable extension arm that is utilized to extend the reach of a user.

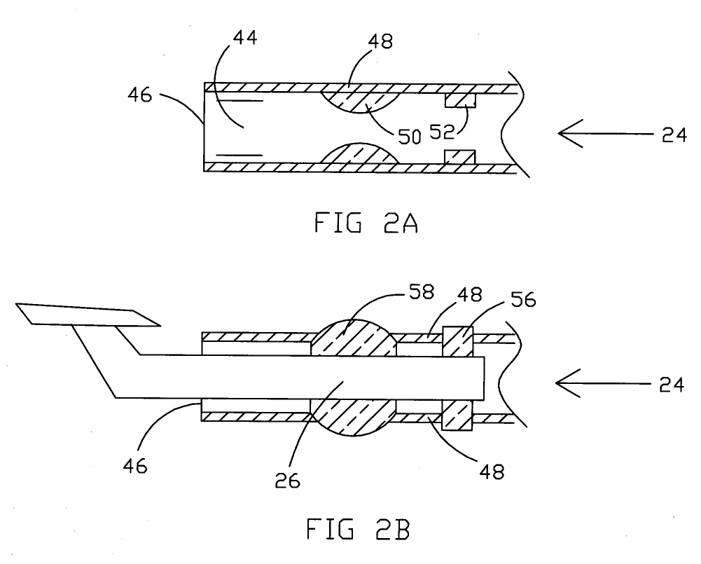

Extension arm 12 has affixed thereto extension arm connector 24 for which some possible embodiments are shown in FIG. 2A-FIG. 6B. Extension arm connector 24 is preferably designed to be removably securable to a standard manual razor blade handle 26. Manual razor blade handle 26 is generally available in a fairly standard construction although there are minor variations in size, length, diameter, and so forth from brand to brand.

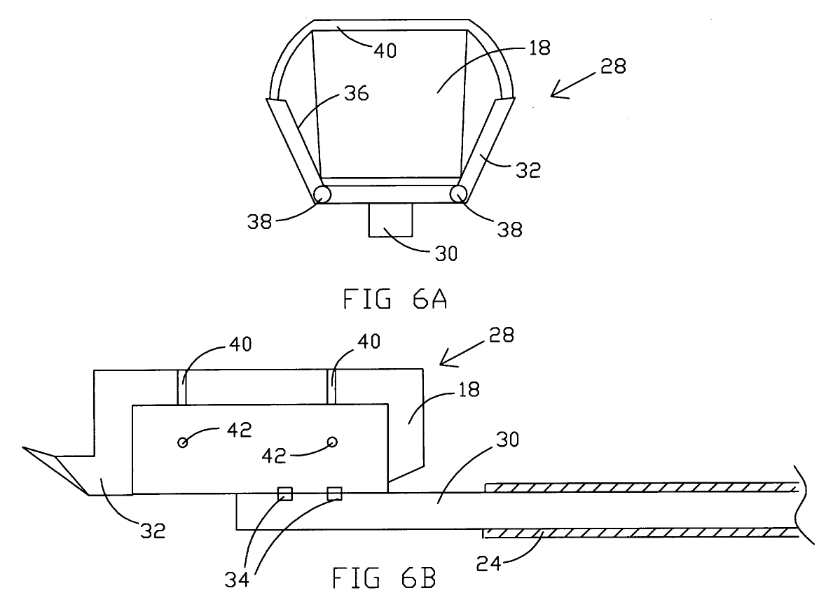

In a preferred embodiment, shaver system 10 may also comprise an electric razor adaptor 28. Electric razor adaptor 28 preferably comprises a handle portion 30, which is preferably shaped in a substantially similar manner as a typical or representative razor blade handle, such as manual razor blade handle 26, so as to be removably securable with respect to extension arm connector 24. Some possible embodiments of electric razor adaptor 28 and handle portion 30 are shown in FIG. 1B, FIG. 6A, and FIG. 6B.

Electric shaver adaptor 28 also comprises a shaver housing adaptor portion 32 which is securable to a housing of electric shaver 18. Shaver housing adaptor portion 32 is preferably affixed to handle portion 30 to thereby form electric razor adaptor 28 by some means such as screws, bolts, or other types of fasteners 34. However any means of securing shaver housing adaptor portion 32 may be utilized including glues, welding, machining, rivets, or any other means. For that matter, shaver housing adaptor portion 32 and handle portion 30 may be built in a one-piece or monolithic construction. In this embodiment, shaver housing adaptor portion 32 comprises a cradle portion with support surfaces 36 supporting a wide variety of electric razor housings and shapes therein. For instance, support surfaces 36 may be hinged, such as with pivotal elements 38 whereby a wide range of electric shaver housings may be accommodated. Support surfaces 36 may be removably affixed to electric shaver 18 by any suitable means including straps 40. However, screws, bolts, or fasteners 42 or other clamping elements could also be utilized. Hook and loop fasteners such as VELCHRO® adhesive strips might also be utilized with or without a cradle portion of support surface 36. Thus, any of numerous types of constructions may be provided for shaver housing adaptor portion 32 and handle portion 30 to thereby form electric razor adaptor 28. It will then be appreciated that electric razor adaptor 28 may be secured to extension arm connector 24 by inserting or otherwise attaching handle portion 30 into extension arm connector 24.

FIG. 2A through FIG. 5 show various possible embodiments of extension arm connector 24 that may be utilized for removably affixing manual razor blade handle 26 or handle portion 30 thereto. FIG. 2A-FIG. 4 disclose extension arm connector 24 as defining receptacle 44 with opening 46 within tubular wall 48 for receiving any standard razor blade handle therein. Thus, FIG. 2A through FIG. 4 each disclose various embodiments of a tubular extension arm connector 24. However, the present invention is not limited to these particular embodiments which are shown only to thereby disclose the concepts of the invention to one of skill in the art.

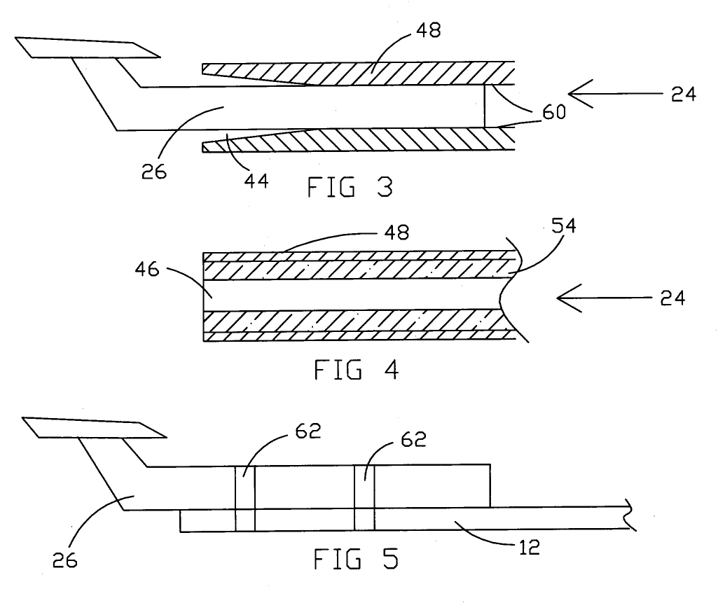

In each of these embodiments, some means is provided for securing the standard razor blade handle, such as manual razor blade handle 26 or handle portion 30, therein. For instance, in the embodiments of FIG. 2A, FIG. 2B, and FIG. 4, a pliable portion is provided which may be an elastomeric or any other type of material which releasably grabs manual razor handle 26. In the embodiment of FIG. 2A elastomeric inner ring portion 50 and/or inner ring portion 52 may be utilized to secure the razor blade handle therein by friction fit. Thus, as the razor handle is inserted into tubular extension arm connector 24, the elastomer compresses and applies a compressing force to the handle to thereby grip and hold the razor handle therein. However, applying a removal force readily permits the user to pull the razor blade handle out whenever desired. Inner ring 48 and/or 52 may be simply a gasket or an O-ring glued or otherwise secured into a notch or could be a part of a sleeve that is glued therein. In fact, the O-ring, gasket, or rubber portion could be placed on the razor blade handle and then the combination inserted into metal tubular 48. FIG. 4 shows an elastomeric sleeve 54 that operates in substantially the same way. In FIG. 2B, a compressible clamp 56, which may be adjustable for clamping various diameter handles, and which may be utilized for clamping manual razor blade handle 26 therein. Additional securing means such elastomeric tubular portion 58 may be utilized whereby tubular 48 at least partially comprises an elastic sleeve. For that matter, tubular 48 may itself be an elastomeric or plastic for friction engagement with manual razor blade handle 26. In FIG. 3 tubular 48 has sloping walls for gripping manual razor blade handle 26. Tubular 48 may be plastic, metal, elastomeric, or any suitable material whereby a friction fit may be utilized to secure manual razor blade handle within receptacle 44. However, because razor blade handle 26 may often have a tapering body, receptacle 44 may also have straight walls so that tubular 48 is simply a constant inner diameter tubular.

In another embodiment as shown in FIG. 5, tubular extension arm connector 24 may comprise a clamping member such as with straps 62. Straps 62 may be adjustable, clamped, may comprise hook and loop fasteners such as VELCHRO® adhesive strips, or utilize elastomerics as desired to provide means for removably affixing extension arm 12 to manual razor blade handle 26 or handle portion 30 to thereby connect to electric razor adaptor 28. Thus, it will be appreciated after review of this specification that extension arm connector 24 may have numerous possible variations.

As one example of operation of shaving system 10 for shaving longer hairs, electric razor 18 may be mounted to adaptor 28 and connected to extension arm 12. The longer hairs can then be conveniently shortened by running electric razor thereover. A mirror may be utilized when shaving the back, if desired. Once the hairs have been shortened, then adaptor 28 may be removed and manual razor blade 16 connected to extension arm 12 in the manner discussed above. The manual razor blade 16 can thereby be utilized to obtain a very close shave.

The foregoing disclosure and description of the invention is therefore illustrative and explanatory of a presently preferred embodiment of the invention and variations thereof, and it will be appreciated by those skilled in the art, that various changes in the design, manufacture, layout, organization, order of operation, means of operation, equipment structures and location, methodology, the use of mechanical equivalents, as well as in the details of the illustrated construction or combinations of features of the various elements may be made without departing from the spirit of the invention. As well, the drawings are intended to describe the concepts of the invention so that the presently preferred embodiments of the invention will be plainly disclosed to one of skill in the art but are not intended to be manufacturing level drawings or renditions of final products and may include simplified conceptual views. Thus, various changes and alternatives may be used that are contained within the spirit of the invention. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative of a presently preferred embodiment and not in a limiting sense.

What is claimed is:

1. A shaving system for shaving one or more remote areas of the body selectively utilizing either a manual razor with a blade or an electric razor, said electric razor comprising an electric razor housing, said manual razor comprising a manual razor handle, said system comprising:
an extension arm having a length suitable for reaching said one or more remote areas of the body; and
an extension arm connector carried by said extension arm, said extension arm connector being alternatively removably securable to either said manual razor handle or said electric razor housing.

2. The system of claim 1, further comprising:
an electric razor adaptor for connecting between said extension arm connector and said electric razor housing.

3. The system of claim 2, wherein said electric razor adaptor comprises a first portion shaped at least substantially similar to said manual razor handle such that said first portion is selectively and removably securable to said extension arm connector, and a second portion securable to said electric razor housing, said first portion and said second portion being secured together such that said electric razor is thereby selectively attachable to said extension arm through said electric razor adaptor.

4. The system of claim 1, wherein said extension arm connector defines therein a receptacle for receiving said manual razor handle.

5. The system of claim 1, further comprising a compressing member for said receptacle for securing said manual razor handle within said receptacle of said extension arm connector.

6. The system of claim 5, wherein said compressing member comprises an elastomeric portion.

7. The system of claim 5, wherein said compressing member comprises a clamp.

8. A shaving system for shaving one or more remote areas of the body, selectively operable for use with a manual razor, said manual razor comprising a razor blade and a manual razor handle said shaving system comprising:
an extension arm having a length suitable for reaching said one or more remote areas of the body;
an extension arm connector carried by said extension arm, said extension arm connector defines therein a receptacle suitably sized for receiving said manual razor handle whereby said connector is releaseably secureable with said manual razor handle.

9. The shaving system of claim 8, wherein said receptacle is defined by internal walls for friction fitting with said manual razor handle.

10. The shaving system of claim 9, wherein said internal walls are tapered.

11. The shaving system of claim 9, wherein said internal walls comprise a compressible material.

12. The system of claim 8, further comprising a compressing member for said receptacle for releaseably securing said manual razor handle within said receptacle of said extension arm connector.

13. The system of claim 12, wherein said compressing member comprises at least one elastomeric portion.

14. The system of claim 12, wherein said compressing member comprises a clamp.

15. A method for shaving one or more remote areas of the body selectively utilizing either a manual razor with a blade or an electric razor or both, said electric razor comprising an electric razor housing, said manual razor comprising a manual razor handle, said method comprising:
securing said electric razor to an extension member;
removing said electric razor from said extension member; and
securing a handle of said manual razor to an extension member.

16. The method of claim 15, wherein said securing of said electric razor to said extension member comprises attaching a bracket portion to said electric razor, said bracket portion being secured to a handle member shaped substantially as a manual razor handle, and attaching said handle member to said extension member.

17. The method of claim 15, further comprising inserting said handle of said manual razor into a receptacle formed on an end of said extension member.
